(19) United States
(12) Patent Application Publication
(10) Pub. No.: US 2025/0345235 A1
(43) Pub. Date: Nov. 13, 2025

(54) MASSAGE BALL AND MASSAGE DEVICE

(71) Applicant: SHENZHEN THOUSANDSHORES TECHNOLOGY CO., LTD., Shenzhen (CN)

(72) Inventors: Ding HE, Shenzhen (CN); Xufeng YANG, Shenzhen (CN); Hangying HE, Shenzhen (CN); Lei WANG, Shenzhen (CN)

(21) Appl. No.: 18/658,687

(22) Filed: May 8, 2024

(51) Int. Cl. A61H 15/00

(52) U.S. Cl. CPC A61H 15/0092; A61H 2015/0042; A61H 2201/0153

(57) ABSTRACT

Disclosure is a massage ball and a massage device. The massage ball includes a ball, a mounting hole is arranged to penetrate through the ball; and a rope, a limiting plate is fixedly sleeved on the rope and the limiting plate is detachably clamped in one end of the mounting hole; one end of the rope is arranged with a clamping assembly, and the clamping assembly is detachably connected with the rope, and the clamping assembly is detachably arranged in another end of the mounting hole. The present disclosure realizes a detachable connection between the ball and the rope by arranging the mounting hole in the ball and arranging the limiting plate and the clamping assembly on the rope, so that users can switch different use modes according to different massage actions when using the ball, thus realizing the function of adaptive massage for different body parts.

### FIELD OF THE DISCLOSURE

The present disclosure relates to the technical field of fitness devices, in particular to a massage ball and a massage device.

### BACKGROUND

With the improvement of people's living standards, fitness has become an important leisure activity in people's daily lives. Therefore, how to achieve small-space fitness has become the main research and development goal of fitness device manufacturers. As an auxiliary device, massage balls can facilitate users to do activities such as back massage, quadriceps massage, and shoulder and neck massage in a small space to relax their body and mind after fitness activities, so the massage balls are sought after by many fitness enthusiasts.

In the prior art, referencing the Chinese Patent Application with publication NO. CN213157567U, a massage ball is disclosed, the ball is independent. When users use the massage ball, the help of the ground, walls, etc. is needed to make the massage ball rotate relative to the corresponding parts of the human body to realize the massage function. When users use the massage ball to massage the back in a standing position, the ball is easy to roll off because it is difficult to control the direction, which affects the continuous massage.

Therefore, the prior art still needs to be improved and developed.

### BRIEF SUMMARY OF THE DISCLOSURE

To solve the problem that the massage ball is difficult to control direction and easy to roll off when a user massages his back in the standing position, which affects the continuous massage, the present disclosure provides a massage ball and a massage device.

The present disclosure is realized by the following technical schemes.

A massage ball, including:

A ball, a mounting hole is arranged to penetrate through the ball; and

A rope, a limiting plate is fixedly sleeved on the rope and the limiting plate is detachably clamped in one end of the mounting hole; one end of the rope is arranged with a clamping assembly, and the clamping assembly is detachably connected with the rope, and the clamping assembly is detachably arranged in another end of the mounting hole.

In the massage ball, a limiting tube is fixedly arranged at a position corresponding to an inner side of the ball in the mounting hole, and the rope is slidably sleeved in the limiting tube;

The limiting plate and the clamping assembly are correspondingly arranged at two ends of the limiting tube.

In the massage ball, a diameter of the limiting plate is matched with an inner diameter of the mounting hole, and when the limiting plate is clamped in the mounting hole, one side of the limiting plate abuts against one end of the limiting tube.

In the massage ball, the clamping assembly includes a clamping portion; a width of the clamping portion is matched with an inner diameter of the limiting tube, and when the clamping assembly is arranged in the mounting hole, the clamping portion is clamped and sleeved in the limiting tube.

In the massage ball, the clamping assembly further includes:
A connecting cap, wherein the clamping portion is fixedly arranged at one side of the connecting cap; and
A connecting ring, wherein the connecting ring is fixedly arranged at one end of the rope and is detachably connected with the clamping portion.

In the massage ball, a connecting hole is arranged on the clamping portion and the connecting ring is detachably sleeved in the connecting hole; a width of the connecting ring is matched with the inner diameter of the limiting tube.

In the massage ball, a center line of the limiting plate and a center line of the rope are arranged on a same straight line, and the rope is fixedly embedded in the limiting plate. In the massage ball, a plurality of ribs are arranged on the ball, and wherein the plurality of ribs are staggered on an outer side of the ball, and a position between two adjacent ribs are smoothly arranged in transition.

In the massage ball, the ball is elastic and the rope is flexible.

A massage device including the above-mentioned massage ball.

Compared with the prior art, the embodiments of the present disclosure have following beneficial effects: The present disclosure realizes a detachable connection between the ball and the rope by arranging the mounting hole in the ball and arranging the limiting plate and the clamping assembly on the rope, so that users can switch different use modes according to different massage actions when using the ball, thus realizing the function of adaptive massage for different body parts. When back massage in the standing position is adopted, the rope is installed to control the direction of the ball, avoid the rolling off situation during the massage process, and ensure the continuity of massage.

### BRIEF DESCRIPTION OF THE DRAWINGS

FIG. 1 is a schematic diagram of a perspective structural of a massage ball of the present disclosure.

FIG. 2 is a structural explosion diagram of the massage ball of the present disclosure.

FIG. 3 is an enlarged view diagram of the A node structure of the massage ball of the present disclosure in FIG. 2.

FIG. 4 is an enlarged view diagram of the B node structure of the massage ball of the present disclosure in FIG. 2.

FIG. 5 is a sectional view diagram of part of the structure of the massage ball of the present disclosure.

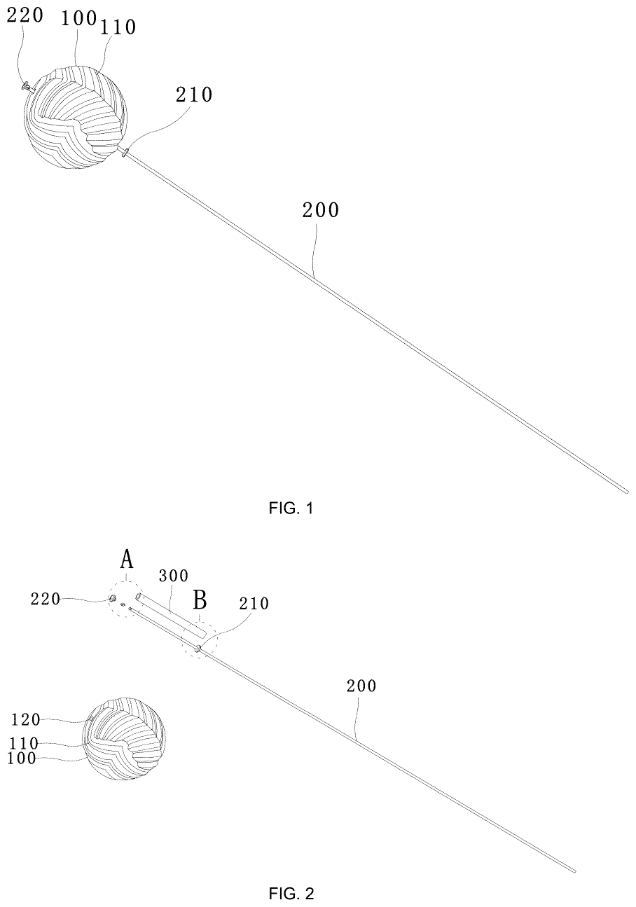

Attached drawing marks in FIGS. 1-5: 100—ball; 110—rib; 120—mounting hole; 200—rope; 210—limiting plate; 220—clamping assembly; 221—clamping portion; 222—connecting hole; 223—connecting cap; 224—connecting ring; 300—limiting tube.

### DETAILED DESCRIPTION OF EMBODIMENTS

To make the purposes, the technical schemes, and the effects of the present disclosure clearer and more definite, more details of the present disclosure are further described in combination with the attached drawings and the embodiments of the present disclosure. It should be understood that the specific embodiments described herein are only used to explain the present disclosure, and are not used to limit the present disclosure.

It should be noted that if there are directional indications (such as up, down, left, right, front, back, etc.) in the embodiments of the present disclosure, the directional indications are only used to explain the relative position relationship and movement situation among components in a specific posture (as shown in the attached drawings), and if the specific posture changes, the directional indications also change accordingly.

Moreover, if there are descriptions related to “first” and “second” in the embodiments of the present disclosure, the descriptions of “first” and “second” are only used for descriptive purposes, and cannot be understood as indicating or implying their relative importance or implicitly indicating the quantity of indicated technical features. Therefore, the features defined as “first” and “second” can explicitly or implicitly include at least one of said features. In addition, the technical solutions of each embodiment can be combined with each other, but they must be based on the realization of those skilled in the art. When the combination of technical solutions is contradictory or impossible, it should be considered that the combination of technical solutions does not exist and is not within the protection scope required by the present disclosure.

In the prior art, referencing to the Chinese Patent Application with publication NO. CN213157567U, a massage ball is disclosed, the ball is independent. When users use the massage ball, the help of the ground, walls, etc. is needed to make the massage ball rotate relative to the corresponding parts of the human body to realize the massage function. When users use the massage ball to massage the back in a standing position, the ball is easy to roll off because it is difficult to control the direction, which affects the continuous massage.

Due to the above problems in the prior art, the present disclosure provides a massage ball, as shown in FIG. 1, the massage ball includes a ball 100, a mounting hole 120 is arranged to penetrate through the ball 100; and a rope 200, a limiting plate 210 is fixedly sleeved on the rope 200 and the limiting plate 210 is detachably clamped in one end of the mounting hole 120; one end of the rope 200 is arranged with a clamping assembly 220, and the clamping assembly 220 is detachably connected with the rope 200, and the clamping assembly 220 is detachably arranged in another end of the mounting hole 120.

The present disclosure realizes a detachable connection between the ball 100 and the rope 200 by arranging the mounting hole 120 in the ball 100 and arranging the limiting plate 210 and the clamping assembly 220 on the rope 200, so that users can switch different use modes according to different massage actions when using the ball, thus realizing the function of adaptive massage for different body parts. When back massage is adopted in the standing position, the rope 200 is installed to control the direction of the ball 100, avoid the rolling off situation during the massage process, and ensure the continuity of massage.

In the above-mentioned embodiment, as shown in FIGS. 1-2, the main body of the massage ball in the present disclosure includes the ball 100 and the rope 200, herein the ball 100 is similar to the massage ball in the prior art, and the effect of massaging specific body parts can also be realized by a fitness user cooperating the massage ball with the ground, the wall, etc. Further in the present disclosure, the mounting hole 120 is arranged through the massage ball, the mounting hole 120 is arranged to penetrate through the ball 100 along a straight line where a center point of the ball 100 is located, so as to realize the mounting adaptation of the ball with the rope 200.

In order to realize the reliable fixation after combining the rope 200 with the ball 100, in one embodiment, the limiting plate 210 is arranged on the rope 200. The limiting plate 210 is fixedly arranged on the rope 200, and correspondingly, the clamping assembly 220 is arranged at one end of the rope 200, and the clamping assembly 220 is detachably connected with the rope 200. In actual installation, a distance between the limiting plate 210 and the one end of the rope 200 where the clamping assembly 220 is arranged should be slightly larger than the diameter of the ball 100. In actual installation, the clamping assembly 220 is detached from the rope 200 in advance, the one end of the rope 200 passes through the mounting hole 120 provided on the ball 100, and then the clamping assembly 220 is combined with the rope 200, so that the clamping assembly 220 and the limiting plate 210 are correspondingly arranged at two ends of the ball 100 corresponding to the mounting hole 120. Furthermore, in actual installation, the limiting plate 210 is combined in the mounting hole 120, and the clamping assembly 220 is combined in another end of the mounting hole 120. In one aspect, because the rope 200 is fixedly connected with the limiting plate 210, the combined relationship between the limiting plate 210 and the ball 100 fixes the rope 200 and the ball 100. In the other aspect, because the clamping assembly 220 arranged at the another end is combined with the ball 100, the rope 200 and the ball 100 can be further fixed, so as to prevent the ball 100 from falling due to the falling of the limiting plate 210.

Based on the above-mentioned embodiment, as shown in FIG. 2, in another embodiment of the present disclosure, a limiting tube 300 is arranged in the ball 100. The limiting tube 300 is arranged at a position in the mounting hole 120 corresponding to an inner side of the ball 100, and is fixedly connected with the ball 100. The advantages of arranging the limiting tube 300 in the embodiment is that the installation position of the clamping assembly 220 and the limiting plate 210 can be limited, which is convenient for installation and subsequent disassembly.

In actual installation, the rope 200 is sleeved inside the limiting tube 300 and can slide freely in the limiting tube 300, which is convenient for the user to sleeve the one end of the rope 200 and pass through the limiting tube 300, thus achieving the effect of rapid installation. In one embodiment, the limiting plate 210 and the clamping assembly 220 are correspondingly arranged at two ends of the limiting tube 300 in actual installation.

Specifically, as shown in FIGS. 2-4, a cross-section of the limiting plate 210 is circular, and a diameter of the limiting plate 210 should be set to match with a diameter of the mounting hole 120 on the ball 100, so as to achieve the effect of clamping the limiting plate 210 in the mounting hole 120. Meanwhile, diameter of the limiting plate 210 is larger than an inner diameter of the limiting tube 300. Therefore, in actual installation, after the limiting plate 210 is clamped into the mounting hole 120, one side of the limiting plate 210 abuts against one end of the limiting tube 300, thus limiting the installation position of the limiting plate 210.

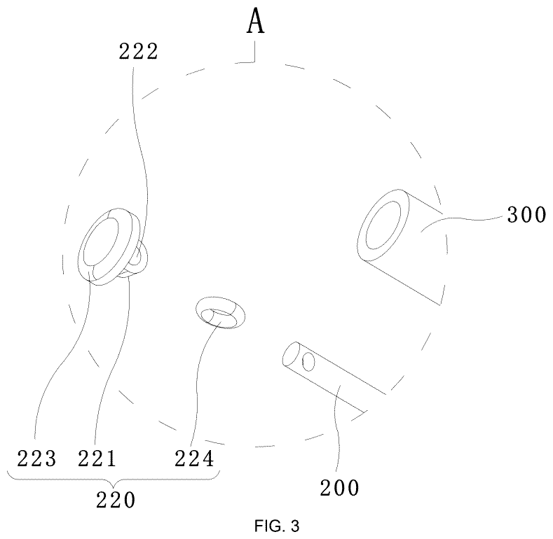

In another embodiment, as shown in FIGS. 2-3, the clamping assembly 220 further includes a clamping portion 221. A width of the clamping portion 221 is matched with the inner diameter of the limiting tube 300. In actual use, when the clamping assembly 220 is installed in the mounting hole 120, the clamping portion 221 is clamped and sleeved in the limiting tube 300, so as to limit the installation position of the clamping assembly 220. In one embodiment, the clamping portion 221 also has the effect of being detachably connected with the one end of the rope 200. When the massage ball of the present disclosure is combined with the rope 200, because the one end of the rope 200 is connected with the clamping portion 221, even if the limiting plate 210 is separated from the mounting hole 120, the clamping assembly 220 can still bear the pulling force of the rope 200 and the gravity of the ball 100, so that the ball 100 can be prevented from being separated from the rope 200 during use; when the massage ball of the present disclosure is in the process of detaching from the rope 200, the clamping relationship between the clamping portion 221 and the limiting tube 300 needs to be released in advance, and the clamping portion 221 and the rope 200 need to be detached before the rope 200 can be separated from the ball 100, so the above structural arrangement of the massage ball of the present disclosure can ensure the use stability.

Specifically, as shown in FIGS. 2-3, in one embodiment, the clamping assembly 220 further includes a connecting cap 223 and a connecting ring 224. The clamping portion 221 is arranged at one side of the connecting cap 223. Specifically, a diameter of the connecting cap 223 is larger than the inner diameter of the limiting tube 300. The advantage of the arrangement is that the connecting cap 223 forms a limiting fit with the limiting tube 300, so as to limit the installation position of the clamping portion 221. Besides, it is convenient for the user to pull the clamping portion 221 out of the limiting tube 300 through the connecting cap 223, which ensures reliable installation and facilitates disassembly. In actual arrangement, the side of the connecting cap 223 corresponding to the outside of the ball 100 should be smoothly arranged to avoid injury to the user during the rolling of the ball 100.

The connecting ring 224 is fixedly arranged in the one end of the rope 200 corresponding to the connecting cap 223 and is detachably connected with the clamping portion 221. Specifically, the connecting ring 224 can be an elastic telescopic clasp commonly used in jewelry in the prior art, or a clasp made of materials with elastic deformation performance, which is not limited in the present application. Besides, a width of the connecting ring 224 is smaller than inner diameter of the limiting tube 300, so that when the clamping portion 221 is sleeved in the limiting tube 300, the connecting ring 224 correspondingly retracts into the limiting tube 300. Accordingly, as shown in FIG. 3, a connecting hole 222 is arranged on the clamping portion 221 at a position where the connecting ring 224 is installed. When in installation state, the connecting ring 224 is sleeved in the connecting hole 222. When it is necessary to detach the connecting ring 224 from the installation portion, the connecting ring 224 can be deformed or expanded to provide space for detaching the clamping portion 221.

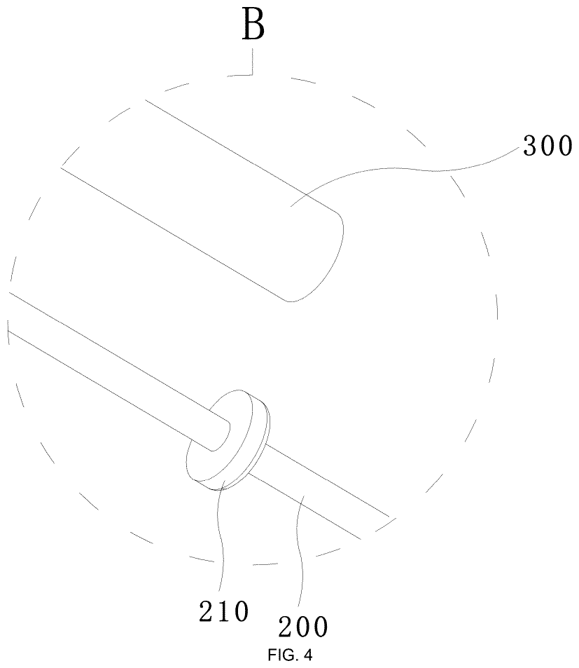

In another embodiment of the present disclosure, as shown in FIG. 2 and FIG. 4, the limiting plate 210 is cylinder-shaped and made of plastic material. In actual manufacture, the limiting plate 210 can be sleeved on a predetermined position of the rope 200 by embedding and covering injection molding, so as to ensure that the limiting plate 210 does not fall off during actual use. Furthermore, in actual manufacture, a center line of the limiting plate 210 and a center line of the rope 200 are arranged on same straight line. The advantage of the arrangement is that when installed, the one end of the rope 200 passes through the limiting tube 300, and the user can directly clamp the limiting plate 210 with the mounting hole 120 by pulling the rope 200, thus improving the mounting speed for the user.

In another embodiment of the present disclosure, as shown in FIG. 1, a plurality of ribs 110 are arranged on the ball 100. The plurality of ribs 110 are staggered on an outer side of the ball 100. The advantage of the arrangement is that, on one hand, the friction force on the surface of the massage ball can be improved to prevent the massage ball from slipping when it is subjected to skin stress from the user; on the other hand, the convex parts of the ribs 110 can concentrate the stress on the user's skin, thus improving the massage effect on specific body parts of the user's skin.

In one embodiment, the ball 100 is made of elastic materials, for instance rubber, silica gel and other materials with elastic deformation performance, and the rope 200 is made of flexible materials to meet pulling requirements of users in different directions and angles.

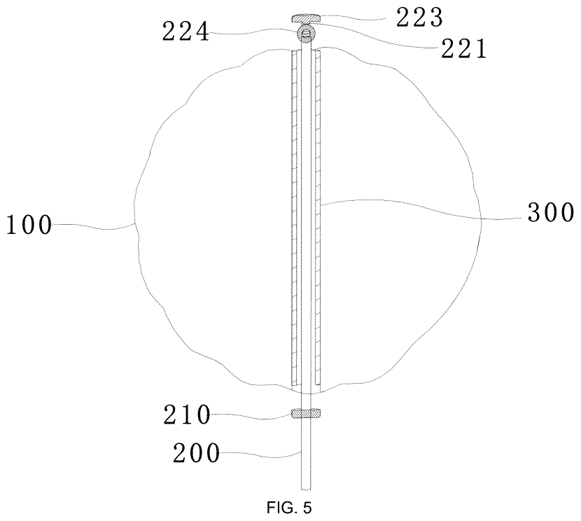

In actual use, as shown in FIG. 2 and FIG. 5, FIG. 2 shows an independent use state of the massage ball of the present disclosure. In the state, the ball 100 is independent, and the user can cooperate with the ground to massage the quadriceps, chest, and abdomen, etc. In this mode, the usage is the same as that of the massage ball in the prior art.

FIG. 5 shows a combined use state of the massage ball of the present disclosure. In the present state, the ball 100 is combined with the rope 200, and the user can massage the back, shoulders and neck by pulling the rope 200 to control the position. In this mode, the ball 100 can be prevented from slipping off and the continuity of massage can be ensured.

The process of changing the massage ball of the present disclosure from the state shown in FIG. 2 to the state shown in FIG. 5 is as follows:

The connection between the connecting ring 224 on the rope 200 and the clamping portion 221 is disconnected by the user, and one end of the rope 200 arranged with the connecting ring 224 is passed through one end of the limiting tube 300 arranged in the ball 100 to the other end of the limiting tube 300, then the rope 200 is pulled. During the process, the limiting plate 210 is clamped and fixed with the mounting hole 120 of the ball 100 under the pulling action of the rope 200. Then the connecting ring 224 is clamped with the clamping portion 221, and the connecting cap 223 is pressed to clamp the clamping portion 221 with the corresponding end of the limiting tube 300. During the process, the redundant rope 200 falls back into the limiting tube 300, thus the combination of the rope 200 and the ball 100 is completed. In actual use, even if the clamping relationship between the limiting plate 210 and the mounting hole 120 is released due to rope tension, the combination state is maintained due to the connection relationship between the clamping assembly 220 and the rope 200, thus effectively preventing the ball 100 from falling off from the rope 200 during use, and facilitating the maintenance of the user's massage continuity.

Based on the above-mentioned embodiment, the present disclosure further provides a massage device including the above-mentioned massage ball, which includes a ball, a mounting hole is arranged to penetrate through the ball; and a rope, a limiting plate is fixedly sleeved on the rope and the limiting plate is detachably clamped in one end of the mounting hole; one end of the rope is arranged with a clamping assembly, and the clamping assembly is detachably connected with the rope, and the clamping assembly is detachably arranged in another end of the mounting hole. The present disclosure realizes a detachable connection between the ball and the rope by arranging the mounting hole in the ball and arranging the limiting plate and the clamping assembly on the rope, so that users can switch different use modes according to different massage actions when using, thus realizing the function of adaptive massage for different body parts. When back massage is adopted in the standing position, the rope is installed to control the direction of the ball, avoid the rolling situation during the massage process, and ensure the continuity of massage.

In summary, the present disclosure provides a massage ball and a massage device. The massage ball includes a ball, a mounting hole is arranged to penetrate through the ball; and a rope, a limiting plate is fixedly sleeved on the rope and the limiting plate is detachably clamped in one end of the mounting hole; one end of the rope is arranged with a clamping assembly, and the clamping assembly is detachably connected with the rope, and the clamping assembly is detachably arranged in another end of the mounting hole. The present disclosure realizes a detachable connection between the ball and the rope by arranging the mounting hole in the ball and arranging the limiting plate and the clamping assembly on the rope, so that users can switch different use modes according to different massage actions when using, thus realizing the function of adaptive massage for different body parts. When back massage is adopted in the standing position, the rope is installed to control the direction of the ball, avoid the rolling situation during the massage process, and ensure the continuity of massage.

It should be noted that the implementation of the present disclosure is not limited to the above embodiments and it can be improved or transformed according to the above description for those skilled in the field, and all these improvements and transformations should be included in the protection scope of the attached claims of the present disclosure.

What is claimed is:

1. A massage ball, comprising:
a ball, wherein a mounting hole is arranged to penetrate through the ball; and
a rope, wherein a limiting plate is fixedly sleeved on the rope and the limiting plate is detachably clamped in one end of the mounting hole; one end of the rope is arranged with a clamping assembly, and the clamping assembly is detachably connected with the rope, and the clamping assembly is detachably arranged in another end of the mounting hole.

2. The massage ball according to claim 1, wherein a limiting tube is fixedly arranged at a position corresponding to an inner side of the ball in the mounting hole, and the rope is slidably sleeved in the limiting tube;
the limiting plate and the clamping assembly are correspondingly arranged at two ends of the limiting tube.

3. The massage ball according to claim 2, wherein a diameter of the limiting plate is matched with an inner diameter of the mounting hole, and when the limiting plate is clamped in the mounting hole, one side of the limiting plate abuts against one end of the limiting tube.

4. The massage ball according to claim 2, wherein the clamping assembly comprises a clamping portion; a width of the clamping portion is matched with an inner diameter of the limiting tube, and when the clamping assembly is arranged in the mounting hole, the clamping portion is clamped and sleeved in the limiting tube.

5. The massage ball according to claim 4, wherein the clamping assembly further comprises:
a connecting cap, wherein the clamping portion is fixedly arranged at one side of the connecting cap; and
a connecting ring, wherein the connecting ring is fixedly arranged in the one end of the rope and is detachably connected with the clamping portion.

6. The massage ball according to claim 5, wherein a connecting hole is arranged on the clamping portion and the connecting ring is detachably sleeved in the connecting hole; a width of the connecting ring is matched with the inner diameter of the limiting tube.

7. The massage ball according to claim 1, wherein a center line of the limiting plate and a center line of the rope are arranged on a same straight line, and the rope is fixedly embedded in the limiting plate.

8. The massage ball according to claim 1, wherein a plurality of ribs are arranged on the ball, and wherein the plurality of ribs are staggered on an outer side of the ball, and a position between two adjacent ribs are smoothly arranged in transition.

9. The massage ball according to claim 1, wherein the ball is elastic and the rope is flexible.

10. A massage device, comprising the massage ball according to claim 1.
